(19) United States
(12) Patent Application Publication
(10) Pub. No.: US 2009/0266498 A1
(43) Pub. Date: Oct. 29, 2009

(54) Smoke curtain

(76) Inventors: Andrew Paul Cooper, Hampshire (GB); James Martin Reed, Elson (GB)

Correspondence Address: LAMBERT & ASSOCIATES, P.L.L.C., 92 STATE STREET, BOSTON, MA, 02109-2004, US

(21) Appl. No.: 12/384,418

(22) Filed: Apr. 3, 2009

(30) Foreign Application Priority Data
Apr. 4, 2008 (GB) 08061178.8

(51) Int. Cl. A47H 23/01; A44B 21/00; A44B 18/00; E06B 9/56

(52) U.S. Cl. 160/309; 160/349.1; 24/455; 24/442

(57) ABSTRACT

A heat resistant curtain has a vent typically extending up from a bottom edge. At the vent, flaps of the curtain on either side of the vent have marginal overlaps. To these are stitched elevated temperature resistant hook and loop fastening tapes. These normally keep the vent closed. The curtain is provided with a bottom bar drawn up to close the head box when the curtain is not deployed. When the curtain is deployed, the bottom bar rests on the floor.

### CROSS REFERENCE TO RELATED APPLICATION

This application takes priority from and claims the benefit of United Kingdom Patent Application Serial No. 0806117.8 filed on Apr. 4, 2008.

### BACKGROUND OF THE INVENTION

1. Field of the Invention The present invention relates to a smoke curtain.

2. Description of the Related Art

In a building fire, it is clearly desirable for the fire to be contained. However, it is recognised that many, if not the majority of, fire related deaths occur as result of asphyxia from smoke from the fire. For this reason, fire regulations now have a greater emphasis on smoke containment than previously.

Deployment of smoke curtains at an early stage of a fire is important, but can result in people escaping from the fire being on the wrong side of the curtain. The present invention addresses this.

### SUMMARY OF THE INVENTION

The object of the present invention is to provide an improved smoke curtain.

According to a first aspect of the invention there is provided a smoke curtain having:

at least one openable vent in the curtain extending to a bottom edge thereof,

an openable fastening for normally closing the vent and

a bottom bar for stabilising the bottom of the curtain when deployed, the bottom bar having:
at least two members attached to a foot of the curtain on respective opposite sides of the vent and
a discontinuity between the two members at the bottom of the vent; the arrangement allowing a passage flap of the curtain and its bottom bar member to open and provide an opening for passage of a person through it.

The curtain can have a single central vent, arranged for a passage flap to be formed on either or both sides thereof. Alternatively, the curtain can have a pair of vents, with a passage flap forming between them.

It is envisaged that the openable fastening can be of a type requiring movement of a clasp for opening, as in a sliding clasp fastener. In this case the person wish to escape lifts the sliding clasp, which can be weighted to be self closing. However, the fastening is preferably of the type that can be opened by application of pressure to the curtain, as by the person pushing on it. It can be a hook and loop fastening or a magnetic fastening. Such a fastening is applied to an overlap of the curtain at the vent, the fastening being self-closing from the weight of the escape flap and its bottom bar member causing the overlap to close against itself and the fastening to engage.

Preferably the bottom bar has one or more overlaps complementary to the curtain overlap or overlaps.

Normally the person passing through the curtain will do so by pushing on the flap of the curtain to one side of the vent. However, in certain situations, the flap may need to be pulled towards the person, in which case, a grab loop can be stitched to the curtain.

In the preferred embodiment, the smoke curtain has:

laterally extending, stiffening battens, both above and below the top of the vent and

edge fittings for holding the edge of the curtain when deployed.

The edge fittings will normally be in accordance with our European Patent Application No EP1491712.

According to another aspect of the invention there is provided apparatus including a smoke curtain adapted to be deployed from a ceiling to a floor at an aperture, the smoke curtain apparatus comprising:

a curtain per se of heat resistant material having:
at least one openable vent in the curtain extending to a bottom edge thereof,
an openable fastening for normally closing the vent,
edge fittings for holding the edge of the curtain when deployed and
a bottom bar for stabilising the bottom of the curtain when deployed, the bottom bar having:
   at least two members attached to a foot of the curtain on respective opposite sides of the vent and
   a discontinuity between the two members at the bottom of the vent;

a deployment mechanism to be mounted at the ceiling for lowering the curtain for deployment and raising it as required; and

a pair of ceiling-to-floor guides to be mounted at opposite edges of the aperture, the edge fittings of the curtain engaging in the ceiling-to-floor guides when the curtain is deployed to hold it against pulling from the guides.

Preferably the deployment mechanism includes a roller and around which the curtain is wound when not deployed and means for driving the roller to lift the curtain. Alternatively, the mechanism can be adapted to lift the curtain in rouches or folds.

Conveniently, the ceiling-to-floor guides have two inwards directed lips at each side and the edge fittings are elements attached to the edge of the curtain to engage and be retained by the lips, with the curtain passing in between the lips to provide a smoke seal

Normally the bottom bar will include a rigid bar extending between the ceiling-to-floor guides, with the bottom bar members being above the rigid bar. At least the bottom bar member at the foot of the openable flap being movable with respect to the rigid bar. Where the curtain has a single vent, with the openable flap remaining held at the ceiling-to-floor guide at the opposite edge of the flap from the vent, the bottom bar member will be connected to the rigid bar at the opposite edge, whereby it pivots with respect to the rigid bar on opening of the flap.

Alternatively, where two vents are provided, the flap can move translationally with respect to the rigid bar, if the fastening is opened at both vents. In this case the flap bottom-bar member is discontinuous from the members to either side and can move translationally with the flap. Preferably the bottom bar members to either side are fixed to the rigid bar.

Such an arrangement—with flap overlaps on the same side at each vent—allows for passage in one direction only where passage is in the direction of flap movement. Alternatively, with flap overlaps on opposite sides of the flap at opposite edges, the flap and bottom bar can pivot in one direction about one fastening for passage in one direction and in the other direction about the other fastening for passage in the other direction.

### BRIEF DESCRIPTION OF THE DRAWINGS

To help understanding of the invention, a specific embodiment thereof will now be described by way of example and with reference to the accompanying drawings, in which:

FIG. 1 is a front view of a single vent smoke curtain in accordance with the invention;

FIG. 2 is a plan cross-sectional view on the line II-II in FIG. 1;

FIG. 3 is a plan cross-sectional view on the line III-III in FIG. 1;

FIG. 4 is an elevational cross-sectional view on the line IV-IV in FIG. 1;

FIG. 5 is a view similar to FIG. 1 of a double vent smoke curtain in accordance with the invention; and

FIG. 6 is a plan cross-sectional view on the line VI-VI in FIG. 5.

### DETAILED DESCRIPTION OF THE PREFERRED EMBODIMENT

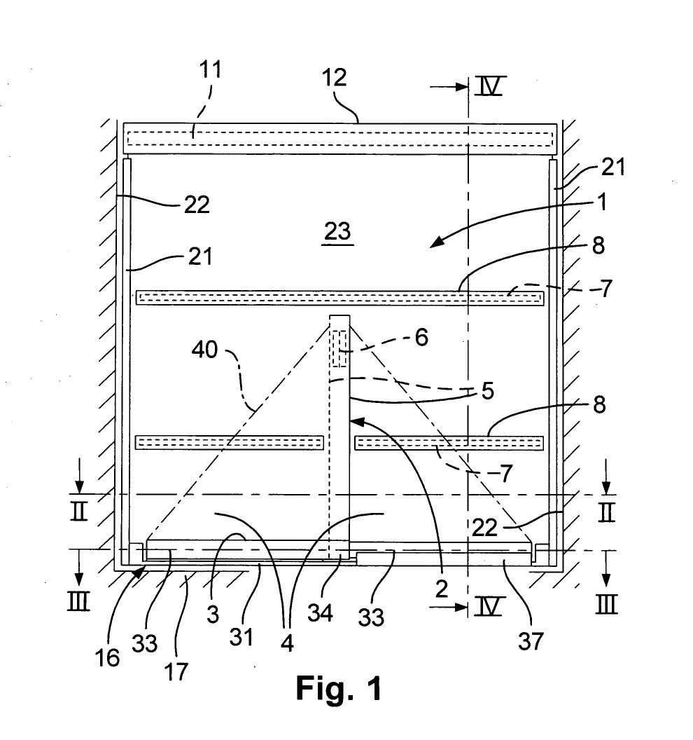

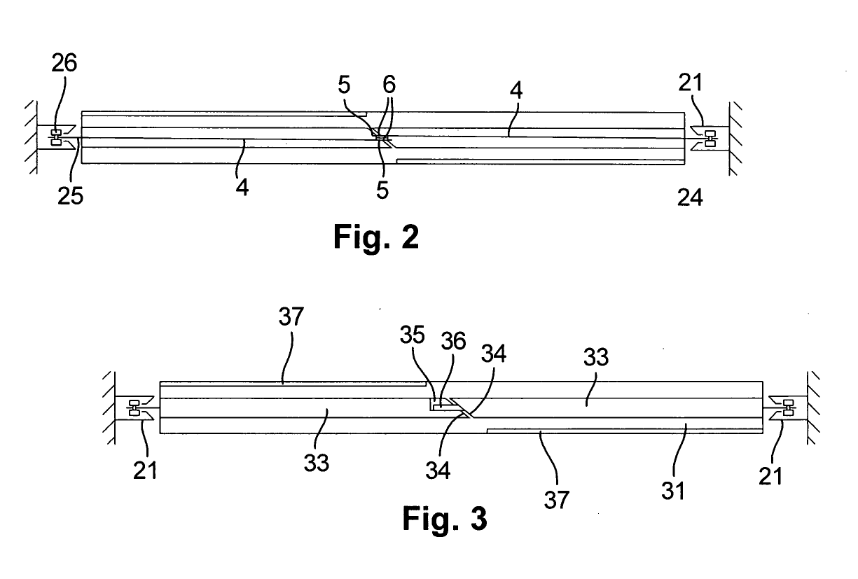

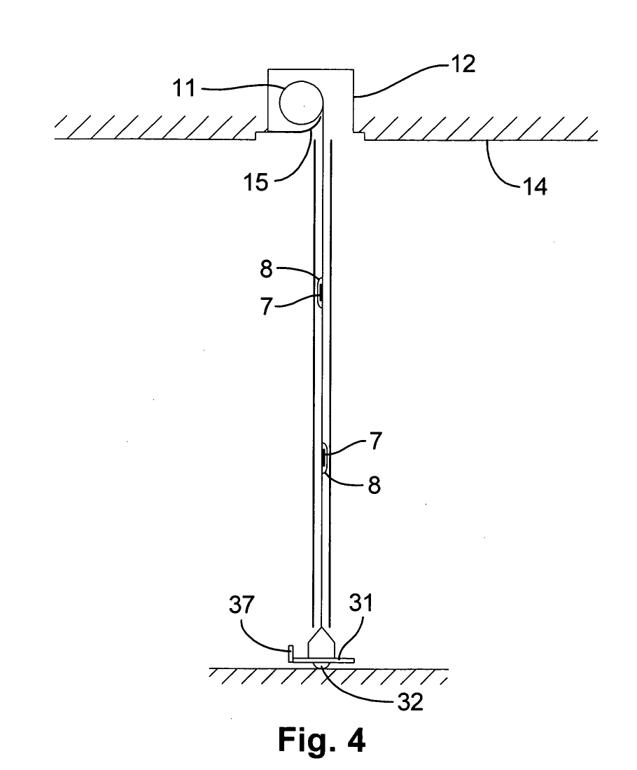

Referring first FIGS. 1 to 4 of the drawings, the curtain I shown is of heat resistant material, typically EFP2/1000S material from Coopers Fire Limited, Havant, England. When deployed, it has a vent 2 typically extending up 2½ metres from a bottom edge 3, the drop of the curtain being typically 4 metres. At the vent, flaps 4 of the curtain on either side of the vent have marginal overlaps 5. To these are stitched elevated temperature resistant hook and loop fastening tapes 6. These normally keep the vent closed.

Both above and below the extent of the vent, the curtain has horizontal stiffening battens 7 in pockets 8.

When not deployed, the curtain is wound on a roller 11 in a head box 12, mounted in a ceiling 14. The head box is provided with a seal 15 positioned to bear against the curtain when the latter is deployed, to close any smoke flow route in the head box and past the roller. The curtain is provided with a bottom bar 16 drawn up to close the head box when the curtain is not deployed. When the curtain is deployed, the bottom bar rests on the floor 17. It can be locked in position typically by electromechanical latches (not shown) at the bottom of the ceiling-to-floor guides 21.

The ceiling-to-floor guides 21 are provided on walls 22 at the edges of the aperture 23 to be closed by the curtain when deployed. These have in-turned lips 24 between which the edges 25 of the curtain extend. Retention elements, in the form of small rolling element bearings 26 are attached intermittently along the edges. They hold the edges of the deployed curtain into the guides. The combined effect of these edge arrangements and the stiffening battens 7 is to keep the curtain flat when deployed.

The bottom bar 16 has a head box closure plate 31, extending rigidly across the width of the aperture between the guides 21. On its underside, the closure plate carries a contact switch 32 for halting deployment of the curtain, should an obstruction be encountered. The curtain is connected to bottom bar members 33 associated with the closure plate, but free to move with respect to it, at least centrally of the closure plate. At the edges of the curtain, the edges 25 are connected to both the closure plate and the bar members. The result is that the bottom bar members are pivotally attached to the bottom of the guides 21 (when the curtain is deployed). The pivotable members 33 extend in along the bottom of the curtain as far as the vent, where they have chamfered overlaps 34, complementary to the curtain overlaps 5. One of the pivotable members has a slot 35 and the other has a tongue 36, engageable in the slot. The tongue and the slot have complementary magnets (not shown) where by the tongue is normally held in the slot. Thus the bottom bar members form a separable continuous member, which holds the bottom of the curtain steady as if it were connected to the closure plate 31. The bottom bar is self-aligning.

Should a person be caught the wrong side of the curtain when deployed, pressure on the curtain will cause the hook and loop fastening tape to release and the vent to open for escape of the person. In order for both bottom bar members not to move and risk them getting back to front on closure, the closure plate has upstands 37 preventing opening movement in the bar having its overlap, and that of the curtain at the vent, on the side of the curtain whence the person is seeking to escape. The result is that the curtain on the other side of the vent can be pushed away. This part of the curtain then forms an open flap 4 hinging about a line 40 from the top of the vent to the corresponding guide end of its bottom bar member. The battens crossing this line 40 flex to allow the flap to open.

After passage of the person, the weight of the curtain and the bottom bar member causes it to swing back into position, with the hook and loop fastening re-engaging and the slot and tongue re-engaging. The battens cross the line 40 act in straightening to urge the flap to close.

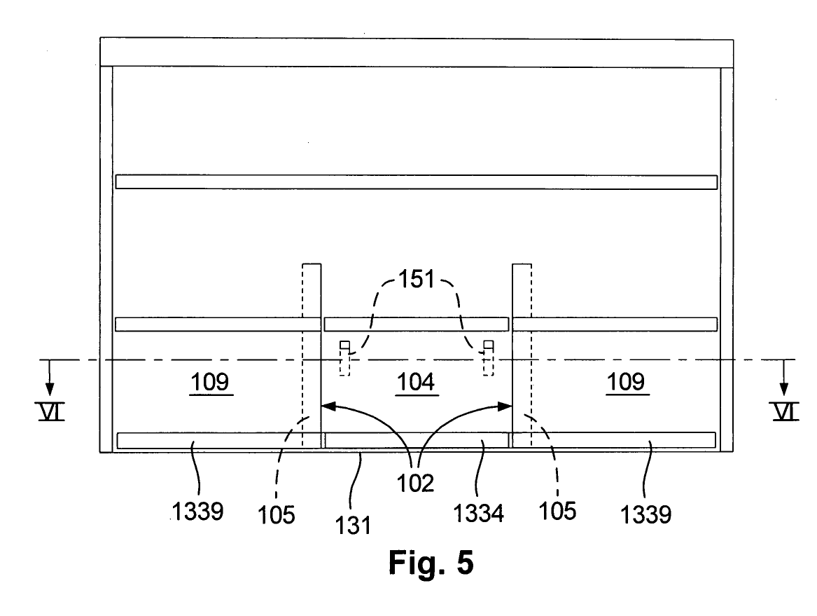

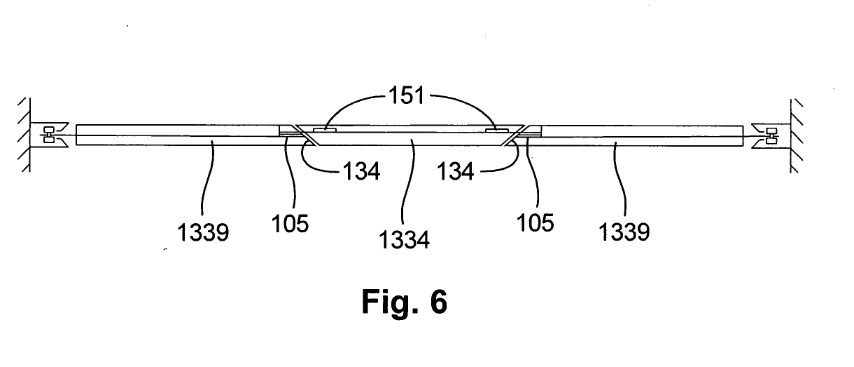

Referring on to FIGS. 5 & 6, the curtain there shown has two vents 102, with an openable flap 104 of the curtain therebetween. The portions 109 of the curtain on either side of flap 104 are not intended to open and their bottom bar members 1339 are attached to the rigid member 131. The bottom bar member 1334 at the foot of the flap is free of the rigid member. The bottom bar members have chamfered overlaps 134 allowing the member 1334 to move in one direction only, the curtain overlaps 105 being similarly arranged. The curtain will be installed with the opening direction being in the expected escape direction. In order to allow opening for escape in the other direction, the central flap is provided with a grab loop 151 on the side to which the flap must be moved to open it.

The invention is not intended to be restricted to the details of the above described embodiment. For instance, the roller mechanism can be replaced by a rouche deployment system. The hook and loop fastening can be replaced by magnets, which whilst bulky have the advantage of applying a positive closure force.

Where the curtain material is to a suitable specification, a smoke curtain apparatus in accordance with the invention can be installed for use as a fire curtain.

1. A smoke curtain having:
at least one openable vent in the curtain extending to a bottom edge thereof,
an openable fastening for normally closing the vent and
a bottom bar for stabilising the bottom of the curtain when deployed, the bottom bar having:
at least two members attached to a foot of the curtain on respective opposite sides of the vent and
a discontinuity between the two members at the bottom of the vent;
the arrangement allowing a passage flap of the curtain, that is to say a portion of the curtain edged by the vent and able to be swung out of a plane substantially occupied by the rest of the curtain, and its bottom bar member to open and provide an opening for passage of a person through it.

2. A smoke curtain according to claim 1, wherein a single central vent is provided, the arrangement providing for a passage flap on either or both sides thereof.

3. A smoke curtain according to claim 1, wherein the curtain has a pair of vents, the arrangement providing for a passage flap between them.

4. A smoke curtain according to claim 1, wherein the openable fastening is of a type requiring movement of a clasp for opening.

5. A smoke curtain according to claim 4, wherein the openable fastening is a sliding clasp fastener.

6. A smoke curtain according to claim 4, wherein a sliding clasp of the fastener is weighted for self closing.

7. A smoke curtain according to claim 1, wherein the openable fastening is of a type that can be opened by application of pressure to the curtain.

8. A smoke curtain according to claim 7, wherein the openable fastening is a hook and loop fastening or a magnetic fastening applied to an overlap of the curtain at the vent.

9. A smoke curtain according to claim 1, wherein the bottom bar has one or more overlaps, complementary to the curtain overlap or overlaps where provided.

10. A smoke curtain according to claim 1, wherein the curtain includes a grab loop attached to the curtain for opening of a flap thereof.

11. A smoke curtain according to claim 1, including
laterally extending, stiffening battens, both above and below the top of the vent and
edge fittings for holding the edge of the curtain when deployed.

12. Smoke curtain apparatus comprising:
A smoke curtain having:
at least one openable vent in the curtain extending to a bottom edge thereof,
an openable fastening for normally closing the vent and
a bottom bar for stabilising the bottom of the curtain when deployed, the bottom bar having:
at least two members attached to a foot of the curtain on respective opposite sides of the vent and
a discontinuity between the two members at the bottom of the vent;
the arrangement allowing a passage flap of the curtain, that is to say a portion of the curtain edged by the vent and able to be swung out of a plane substantially occupied by the rest of the curtain, and its bottom bar member to open and provide an opening for passage of a person through it;
a deployment mechanism to be mounted at the ceiling for lowering the curtain for deployment and raising it as required; and
a pair of ceiling-to-floor guides to be mounted at opposite edges of the aperture, the edge fittings of the curtain engaging in the ceiling-to-floor guides when the curtain is deployed to hold it against pulling from the guides.

13. Smoke curtain apparatus according to claim 12, wherein the deployment mechanism includes a roller, around which the curtain is wound when not deployed and means for driving the roller to lift the curtain.

14. Smoke curtain apparatus according to claim 13, wherein the deployment mechanism includes a head box and a seal in the head box bearing against the curtain when deployed to close any smoke flow route in the head box and past the roller.

15. Smoke curtain apparatus according to claim 12, wherein the deployment mechanism is adapted to lift the curtain in rouches or folds.

16. Smoke curtain apparatus according to claim 12, wherein the ceiling-to-floor guides have two inwards directed lips at each side and the edge fittings are elements attached to the edge of the curtain to engage and be retained by the lips, with the curtain passing in between the lips to provide a smoke seal.

17. Smoke curtain apparatus according to claim 12, wherein the bottom bar includes a rigid bar extending between the ceiling-to-floor guides, with the bottom bar members being above the rigid bar, at least the bottom bar member at the foot of the openable flap being movable with respect to the rigid bar.

18. Smoke curtain apparatus according to claim 17, wherein the curtain has a single vent, with the openable flap being held at the ceiling-to-floor guide at the opposite edge of the flap from the vent, the bottom bar member being connected to the rigid bar at the opposite edge, whereby it pivots with respect to the rigid bar on opening of the flap.

19. Smoke curtain apparatus according to claim 17, wherein the curtain has two vents, the flap being movable translationally with respect to the rigid bar, with the fastening being opened at both vents, the flap bottom-bar member being discontinuous from the members to either side and movable translationally with the flap.

20. Smoke curtain apparatus according to claim 19, wherein the bottom bar members to either side are fixed to the rigid bar.

21. Smoke curtain apparatus according to claim 20, including flap overlaps on the same side at each vent, the arrangement allowing for passage in one direction only where passage is in the direction of flap movement.

22. Smoke curtain apparatus according to claim 20, including flap overlaps on opposite sides of the flap at opposite edges, the arrangement allowing the flap and bottom bar to pivot in one direction about one fastening for passage in one direction and in the other direction about the other fastening for passage in the other direction.
